(19) United States
(12) Patent Application Publication
(10) Pub. No.: US 2024/0266588 A1
(43) Pub. Date: Aug. 8, 2024

(54) CELL ASSEMBLY FOR ELECTRODE STRUCTURAL OBSERVATION

(71) Applicant: HONDA MOTOR CO., LTD., Tokyo (JP)

(72) Inventor: Atsushi SAKURAI, Saitama (JP)

(21) Appl. No.: 18/389,789

(22) Filed: Dec. 20, 2023

(30) Foreign Application Priority Data
Feb. 8, 2023 (JP) 2023-017480

(51) Int. Cl. H01M 10/04; G01N 23/046; H01M 10/48

(52) U.S. Cl. CPC H01M 10/0468; G01N 23/046; H01M 10/48; G01N 2223/611

(57) ABSTRACT

A cell assembly for structural observation for observing the internal structure of a cell by X-ray CT includes: a pair of main restraining members which restrain a cell serving as an observation target by sandwiching from both sides thereof; and auxiliary restraining members of relatively thinner than the main restraining member, and are respectively interposed between the cell and the pair of the main restraining members, in which the pair of main restraining members are respectively configured by a plurality of partial restraining members disposed with a predetermined gap, and the auxiliary restraining members are disposed to overlap the gap of the main restraining members in a restraining direction view of the cell.

This application is based on and claims the benefit of priority from Japanese Patent Application No. 2023-017480, filed on 8 Feb. 2023, the content of which is incorporated herein by reference.

### BACKGROUND OF THE INVENTION

### Field of the Invention

The present invention relates to a cell assembly for electrode structural observation.

### Related Art

A cell which is a constituent element of a secondary battery module is accompanied by expansion and contraction during charging and discharging. For this reason, the electrodes are often used in a state restrained from the thickness direction. A technique for observing the electrode structure in a state imitating such a usage state has been proposed. For example, it is a technique which observes an electrode cross section by SEM (scanning microscope) or a confocal optical system in a state restraining the electrode by a restraining member from the thickness direction. With these techniques, in the case of being an electrode having a great expansion/contraction amount, it is difficult to completely suppress the expansion of the electrode to the projecting direction from the machined cross section for observation. For this reason, there is concern over the observation result differing from the behavior of the structure during actual use. On the other hand, although the above concern is eliminated if observing by X-ray CT, for which the machining of a cross section for observation is unnecessary, the image quality of X-ray CT images declines by X-ray absorption in the restraining member restraining the electrode from the thickness direction. The decline in image quality becomes an obstacle to making detailed observation.

As the cell assembly for electrode structural observation for performing observation by X-ray CT on this cell, in a state restraining the cell of a secondary battery from the thickness direction by a restraining member, it has been proposed to adopt an assembly made using a disk-shaped restraining member providing with a hole in the center for passing through X rays (for example, refer to Patent Document 1).

Patent Document 1: Japanese Unexamined Patent Application, Publication No. 2012-159311

### SUMMARY OF THE INVENTION

With the cell assembly for electrode structural observation of Patent Document 1, for the hole passing X rays therethrough provided at the center of the disk-shaped member, which is the restraining member, a hole in a condition providing a tapered surface which expands in diameter to outwards at the inner circumferential edge thereof has been disclosed. It is said to be possible to introduce X-rays from a wide angle range to the cell, which is the observation target. However, when bringing the angle of incidence of X-rays closer to 90 degrees by relatively turning the cell, it is inevitable that the introduction of X-rays to the cell is inhibited by the inner circumferential edge of the hole through which the X-rays pass.

The present invention has been made taking account of the above situation, and has an object of providing a cell assembly for electrode structural observation for which the introduction of X rays to this cell is not inhibited, even when the angle of incidence of X-rays approaches 90 degrees, in the case of relatively turning the cell which is the observation target around the pivot axis orthogonal to the optical axis of X-rays.

A cell assembly for structural observation (for example, the cell assembly 1 for structural observation) according to a first aspect of the present invention for observing an internal structure of a cell by X-ray CT includes: a pair of main restraining members (for example, the main restraining members 4 described later) which restrain the cell (for example, the cell 3 described later) serving as an observation target by sandwiching from both sides thereof; and an auxiliary restraining member (for example, the first auxiliary restraining member 5, second auxiliary restraining member 6 described later) which is relatively thinner than the main restraining member, and is interposed between each of the pair of the main restraining members (for example, the first main restraining member 7, second main restraining member 8 described later) and the cell, in which each of the pair of the main restraining members is configured by a plurality of partial restraining members (for example, the upper first restraining member 71, lower first restraining member 72; upper second restraining member 81, lower second restraining member 82 described later) disposed with a predetermined gap (for example, the gap g1, ga g2 described later), and the auxiliary restraining member is disposed to overlap the gap of the main restraining members when viewed in a restraining direction of the cell.

According to a second aspect of the present invention, the cell assembly for structural observation as described in the first aspect further includes: a rotation support member (for example, the rotation support member 2 described later) which supports the main restraining member so as to rotate around an axis orthogonal to a plane defined by an irradiation direction of X-ray from the X-ray CT and a longitudinal direction of the gap.

According to a third aspect of the present invention, in the cell assembly for structural observation as described in the first or second aspect, the auxiliary restraining member is an insulator.

According to a fourth aspect of the present invention, in the cell assembly for structural observation as described in the second or third aspect, two fastening members for fastening between a pair of the main restraining members are provided, the two of the fastening members being disposed to sandwich an electrode opposing part, which is an observation target site of the cell, in a rotation axis direction of rotation of the cell assembly for structural observation by way of the rotation support member.

According to a fifth aspect of the present invention, in the cell assembly for structural observation as described in any one of the second to fourth aspects, a positive electrode terminal and a negative electrode terminal drawn out from the cell are disposed to sandwich an electrode opposing part which is an observation target site of the cell, in a rotation axis direction of rotation of the structural observation cell assembly by way of the rotation support member.

According to a sixth aspect of the present invention, in the cell assembly for structural observation as described in the fifth aspect, a positive electrode busbar housing and a negative electrode busbar housing are respectively provided so as to house a positive electrode busbar connected to the positive electrode terminal and a negative electrode busbar connected to the negative electrode terminal, and the positive electrode busbar housing and the negative electrode busbar housing are disposed to sandwich the electrode opposing part which is an observation target site of the cell, in a rotation axis direction of rotation of the cell assembly for structural observation by way of the rotation support member.

With the cell assembly for structural observation according to the first aspect, in the case of relatively pivoting the cell which is the observation target around a pivot axis orthogonal to the optical axis of X-rays, incidence of X rays to this cell will not be inhibited even if the angle of incidence of X rays approaches 90 degrees, and thus it is possible to perform accurate structural observation.

With the cell assembly for structural observation according to the second aspect, it is possible to carry out the irradiation of X rays to the cell serving as the observation target over the entire circumference around the axis, and thus it is possible to obtain abundant information related to the structure of cells.

With the cell assembly for structural observation according to the third aspect, it is possible to restrain the cell which is the observation target in a state in which useless electrical continuity does not arise.

With the cell assembly for structural observation according to the fourth aspect, the fastening members are separated from the electrode opposing part which is the observation target site of the cell, and thus will not affect observation by X-ray CT.

With the cell assembly for structural observation according to the fifth aspect, since the positive electrode terminal and negative electrode terminal are separated from the electrode opposing part which is the observation target site of the cell, operations on the positive electrode terminal and negative electrode terminal will not affect observation by X-ray CT.

With the cell assembly for structural observation according to the sixth aspect, since the positive electrode busbar housing and negative electrode busbar housing are separated from the electrode opposing part which is the observation target site of the cell, operations on the positive electrode busbar and negative electrode busbar will not affect observation by X-ray CT.

### BRIEF DESCRIPTION OF THE DRAWINGS

FIG. 1 is an exploded perspective view showing a cell assembly for structural observation of the present disclosure;

FIG. 2 is a perspective view of the cell assembly for structural observation in FIG. 1; and

FIG. 3 is a cross-sectional view along the line A-A of the cell assembly for structural observation in FIG. 2.

### DETAILED DESCRIPTION OF THE INVENTION

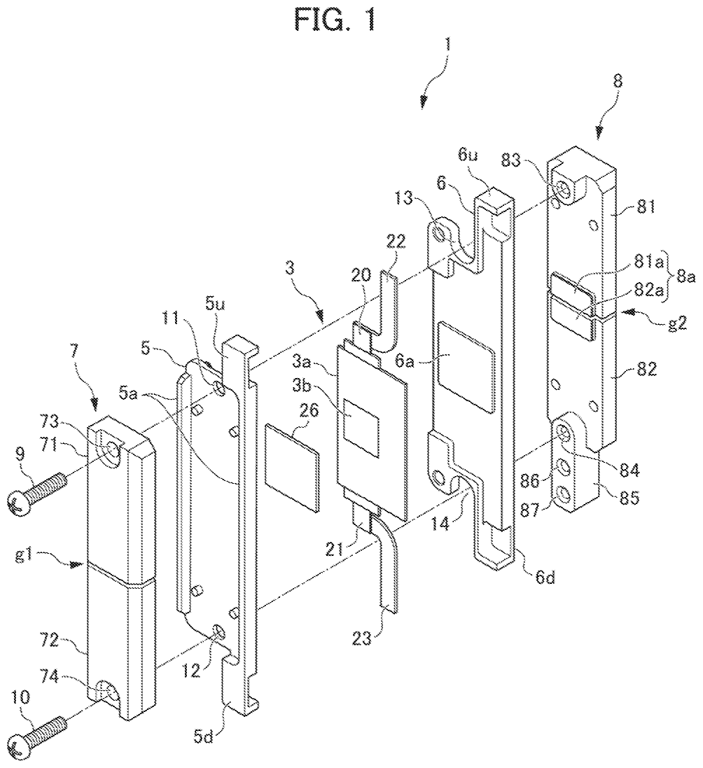

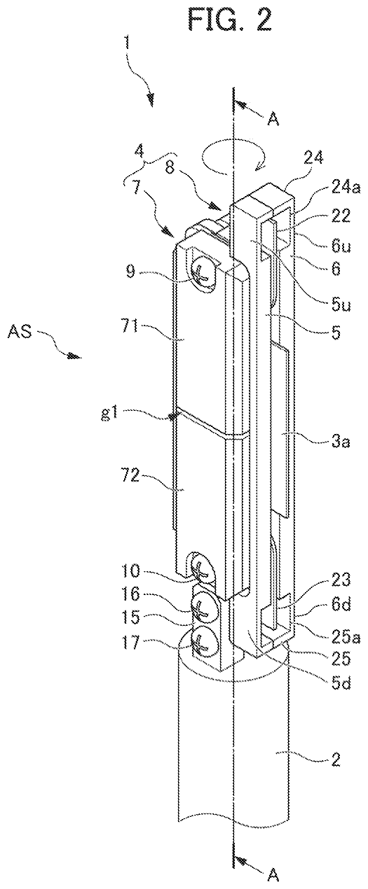

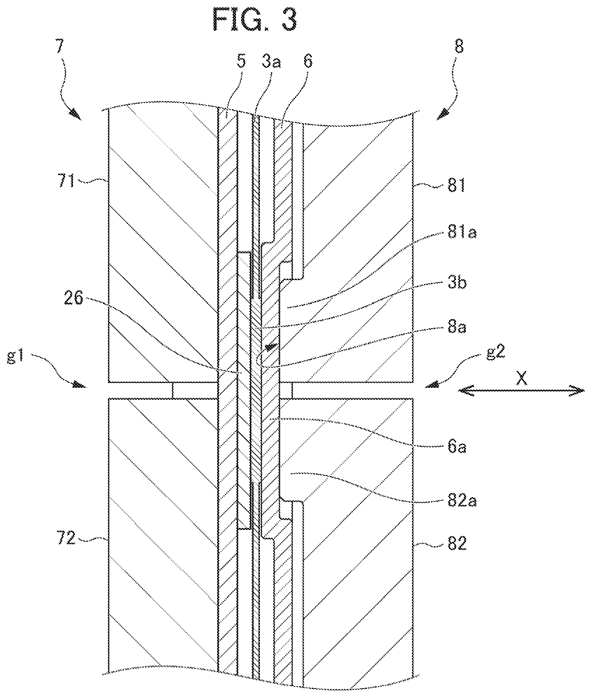

FIG. 1 is an exploded perspective view showing a cell assembly 1 for structural observation of the present disclosure. FIG. 2 is a perspective view of the cell assembly 1 for structural observation. FIG. 3 is a cross-sectional view along the line A-A of the cell assembly 1 for structural observation. In detail, FIG. 1 shows a portion of the cell assembly 1 for structural observation excluding a rotation support member 2 described later, and FIG. 3 shows a neighboring portion of a gap g described later of the cell assembly 1 for structural observation. It should be noted that the up/down direction in the following explanation is a direction viewed in the drawing, for example, is a vertical direction; however, it is not the purpose to limited to this.

The cell assembly 1 for structural observation is an assembly for observing the internal structure of a cell which is a constituent element of a secondary battery module by X-ray CT (not shown). The cell assembly 1 for structural observation includes: a pair of main restraining members 4, which are rigid bodies sandwiching a flat cell 3 serving as the observation target from both sides thereof to restrain; and a first auxiliary restraining member 5 and second auxiliary restraining member 6 respectively interposed between the pair of main restraining members 4 and cell 3.

The pair of main restraining members 4 sandwiches the cell to restrain by the first main restraining member 7 positioned on one lateral side of the cell 3, and the second main restraining member 8 positioned on the other lateral side of the cell 3. Upon this sandwiching, the plate-like first auxiliary restraining member 5 having a main face which is substantially rectangular is interposed between the first main restraining member 7 and one side of the cell 3, and the plate-like second auxiliary restraining member 6 having a main face which is substantially rectangular is interposed between the second main restraining member 8 and the other side of the cell 3. Each of the first auxiliary restraining member 5 and second auxiliary restraining member 6 is relatively thinner than either of the first main restraining member 7 and second main restraining member 8, which are the main restraining members 4. In the first auxiliary restraining member 5, position regulating parts 5a, 5a standing up in the thickness direction from each of both side edges are formed. The relative positions between the first auxiliary restraining member 5 and first main restraining member 7 are restricted by these position regulating parts 5a, 5a. For the second auxiliary restraining member 6, a position regulating means similar to the first auxiliary restraining member 5 is taken. As a result, the first auxiliary restraining member 5 and second auxiliary restraining member 6 are arranged to overlap with the gap between the first main restraining member 7 and second main restraining member 8, which are the main restraining members 4 in the restraining direction view of the cell 3.

The first main restraining member 7 is configured by an upper first restraining member 71 and a lower first restraining member 72, which are each partial restraining members arranged to be separated up and down in the illustration to open a gap g1 at which the corresponding opposing sites are respectively linear and parallel. The second main restraining member 8 is configured by an upper second restraining member 81 and a lower second restraining member 82, which are each partial restraining members arranged to be divided up and down in the illustration to open a gap g2 at which the corresponding opposing sites are respectively linear and parallel. The gap g1 and gap g2 have equal positions in the vertical direction, the gap between parallel opposite sites are equal, and the longitudinal direction of both are orthogonal to the vertical direction. In the present disclosure, these gaps g1 and g2 are collectively referred to as the gap g where appropriate. The X rays from the X-ray source (not shown) pass through the gap g and penetrate the cell 3 defined as an observation target. The penetrating direction of the X rays is shown in FIG. 3 by the bidirectional arrows X. The direction of the arrow X is the irradiation direction of X rays of the X-ray CT.

An upper bolt insertion hole 73 is formed so as to pierce the upper end vicinity of the upper first restraining member 71 in the thickness direction, and a lower bolt insertion hole 74 is formed so as to pierce a lower end vicinity of the lower first restraining member 72 in the thickness direction. On the other hand, an upper female thread hole 83 corresponding to the upper bolt insertion hole 73 of the upper first restraining member 71 is formed in the vicinity of the upper end of the upper second restraining member 81, and a lower female thread hole 84 corresponding to the lower bolt insertion hole 74 is formed in the vicinity of the lower end of the lower second restraining member.

The first main restraining member 7 and second main restraining member 8 are fastened with the appropriate fastening force by an upper bolt 9 and a lower bolt 10 sandwiching the cell 3 via a first auxiliary restraining member 5 and the second auxiliary restraining member 6. The cell 3 is thereby restrained from both sides. Upon this fastening, the bolt 9 inserted from the upper bolt insertion hole 73 is threaded to the upper female thread hole 83, and the holt 10 inserted from the lower bolt insertion hole 74 is threaded to the lower female thread hole 84.

In order to insert the bolt 9 and bolt 10 without problems from the first main restraining member 7 to the second main restraining member 8, the following such configuration is adopted. In other words, a bolt through hole 11 of larger diameter than the outside diameter of the bolt 9 is provided so as to penetrate in the thickness direction in the vicinity of the upper end of the first auxiliary restraining member 5, and a bolt through hole 12 of larger diameter than the outside diameter of the bolt 9 is provided so as to penetrate in the thickness direction in the vicinity of the lower end of the first auxiliary restraining member 5. In addition, a recess 13 to avoid interference with the bolt 9 is formed in the vicinity of the upper end of the second auxiliary retraining member 6, and a recess 14 to avoid interference with the bolt 10 is formed in the vicinity of the lower end of the second auxiliary restraining member 6. It is possible to insert the bolt 9 from the upper bolt insertion hole 73 to the upper female thread hole 83 without interfering with the first auxiliary restraining member 5 and second auxiliary restraining member 6, by way of the bolt through hole 11 and recess 13. Similarly, it is possible to insert the bolt 10 from the lower bolt insertion hole 74 to the lower female thread hole 84 without interfering with the first auxiliary restraining member 5 and second auxiliary restraining member 6, by way of the bolt through hole 12 and recess 14.

A projecting member 85 is provided so as to project from a short-side central site in the vicinity of the lower end of the lower second restraining member 82 to downwards. The projecting member 85 is a member of roughly columnar shape having a larger dimension in the insertion direction of the lower bolt 10 than the thickness dimension of the lower second restraining member 82, and a width dimension in a direction orthogonal to the insertion direction narrower than the width of the lower end of the lower second restraining member 82. The aforementioned lower female thread hole 84 is provided on the upper side of the projecting member 85. On a surface of the projecting member 85 at which the lower female thread hole 84 is open, assembly mounting female thread holes 86 and 87 are provided in parallel downwards from the lower female thread hole 84. In other words, on the same side of the projecting member 85, the lower female thread hole 84, and assembly mounting female thread holes 86 and 87 are provided in parallel in the above order from above to below.

An assembly AS including a pair of main restraining members 4 retraining the cell 3 serving as the observation target by sandwiching from both sides, and the first auxiliary restraining member 5 and second auxiliary restraining member 6 interposed when sandwiching the cell 3 by the main restraining member 4 is mounted on the upper end side of a cylindrical rotation support member 2 extending in the vertical direction. In this mounting, a short prism-like mounting member 15 provided to project upwards to the upper end of the rotation support member 2 can be used. In other words, each leading end side of the two assembly mounting bolts 16, 17 inserted from the mounting member 15 are threaded into the assembly mounting female thread holes 86, 87 provided in the projecting member 85 of the lower second restraining member 82, and the assembly AS is mounted to the rotation support member 2. The rotation support member 2 rotates by a rotary drive mechanism (not shown), whereby the assembly AS turns.

As easily understood by collectively referencing FIGS. 2 and 3, the rotation support member 2 supports the main restraining member 4 so as to rotate around an axis orthogonal to a plane defined by the irradiation direction X of X-rays by X-ray CT (not shown) and the longitudinal direction of the gap g. One embodiment of a cell assembly 1 for structural observation of the present disclosure is configured to include the assembly AS and rotation support member 2.

Herein, in the cell 3, an electrode opposing part 3b, which is a portion at which the separator sheet is opposing the positive electrode active material layer and negative electrode active material layer inside of the central part of the cell body 3a is defined as the observation target site. A positive electrode terminal 20 is led out at the upper edge of the cell body 3a, and a negative electrode terminal 21 is led out at the lower edge of the cell body 3a. A positive electrode busbar 22 is led out from the positive electrode terminal 20, and a negative electrode busbar 23 is led out from the negative electrode terminal 21. The positive electrode terminal 20 and negative electrode terminal 21 are thereby positioned to be distanced from the penetrating site of X-rays of the electrode opposing part 3b, which is the observation target site, in the rotation axis direction of rotation of the assembly AS. For this reason, the positive electrode terminal 20 and negative electrode terminal 21 do not influence observation by X-ray CT. In addition, the aforementioned bolt 9 and bolt 10, as well as the upper female thread hole 83 and lower female thread hole 84 are positioned to be distanced from the penetrating site of X-rays of the electrode opposing part 3b, which is the observation target site, in the rotation axis direction of rotation of the assembly AS. In other words, the site fastened by the bolt 9 and bolt 10, as well as the upper female thread hole 83 and lower female thread hole 84 forms two fastening members, which are a set of a bolt and female thread fastening the first main restraining member 7 and second main restraining member 8, which are the main restraining members 4, and these two fastening members are arranged to sandwich the electrode opposing part 3b, which is the observation target site of the cell 3, in the rotation axis direction of rotation of the assembly AS by the rotation support member 2. For this reason, the bolt 9 and bolt 10, as well as the upper female thread hole 83 and lower female thread hole 84, and thus the aforementioned two fastening members, do not affect observation by X-ray CT.

As in FIG. 1, the positive electrode busbar 22 extends shortly in parallel to the upper edge of the cell body 3a from the connection with the positive electrode terminal 20, bends vertically upwards without reaching the lateral edge of the cell body 3a, and extends upwards by a predetermined dimension to exhibit a form reaching its upper end. In addition, the negative electrode busbar 23 extends shortly in parallel to the lower edge of the cell body 3a from the connection with the negative electrode terminal 21, bends vertically downwards without reaching the lateral edge of the cell body 3a, and extends downwards by a predetermined dimension to exhibit a form reaching its lower end.

A positive electrode busbar housing 24 is formed by the positive electrode busbar housing half 5u formed to project upwards at the upper edge of the first auxiliary restraining member 5, and a positive electrode busbar housing half 6u formed to project upwards at the upper edge of the second auxiliary restraining member 6 being matched so that both housing recesses are facing. The upper end proximity part of the positive electrode busbar 22 is accommodated in the positive electrode busbar housing 24. As in FIG. 2, the positive electrode busbar housing 24 has a window 24a that is open to one side of the assembly AS to allow an electrical input/output operations operation from outside on the positive electrode busbar 22 inside.

A negative electrode busbar housing 25 is formed by a negative electrode busbar housing half 5d formed to project downwards at the lower edge of the first auxiliary restraining member 5, and a negative electrode busbar housing half 6d formed to project downwards at a lower edge of the second auxiliary restraining member 6 being matched so that both housing recesses face each other. A lower end proximity part of the negative electrode busbar 23 is accommodated in the negative electrode busbar housing 25. As in FIG. 2, the negative electrode busbar housing 25 has a window 25a that is open to one side of the assembly AS to allow an electrical input/output operations operation from outside on the negative electrode busbar 23 inside.

The aforementioned window 24a and window 25a are both positioned to be respectively distanced from the penetrating site of X-rays of the electrode opposing part 3b, which is the observation target site. When changing the perspective, the positive electrode terminal 20 and negative electrode terminal 21 leading out from the cell 3 are arranged to sandwich the electrode opposing part 3b, which is the observation target site of the cell 3, in the rotation axis direction of rotation of the assembly AS by the rotation support member 2. In addition, the positive electrode busbar housing 24 and negative electrode busbar housing 25 are provided so as to respectively accommodate the positive electrode busbar 22 connected to the positive electrode terminal 20 and the negative electrode busbar 23 connected to the negative electrode terminal 21, and the positive electrode busbar housing 24 and negative electrode busbar housing 25 are arranged to sandwich the electrode opposing part 3b, which is the observation target site of the cell 3, in the rotation axis direction of rotation of the assembly AS by the rotation support member 2. Upon performing operation of electrical input/output operations from the window 24A and window 25a of the positive electrode busbar housing 24 and negative electrode busbar housing 25 and performing observation by changing the SOC of the cell 3, this operation will not affect observation by X-ray CT.

As mentioned above, the first auxiliary restraining member 5 is interposed between the cell 3 and the first main restraining member 7, which is one member among the pair of main restraining members 4 restraining the cell 3 by sandwiching from both sides; however, in more detail, a spacer 26 is further interposed between the first auxiliary restraining member 5 and one side of the electrode opposing part 3b of the cell 3. In addition, the second auxiliary restraining member 6 is interposed between the cell 3 and the second main restraining member 8, which is the other member among the pair of main restraining members 4; however, in more detail, a convex part 6a formed on the second auxiliary restraining member 6 so as to oppose the other side of the electrode opposing part 3b abuts the electrode opposing part 3b. The back side of the convex part 6a exhibits a concave shape; however, the convex part 8a is formed in the second main restraining member 8 to correspond to the portion exhibiting this concave shape. In other words, the convex part 8a of the second main restraining member 8 abuts the back-side concave portion of the convex part 6a of the second auxiliary restraining member 6, and the convex part 6a presses the other side of the electrode opposing part 3b of the cell 3. The convex part 8a of the second main restraining member 8 is configured by the convex part 81a of the upper second restraining member 81 and the convex part 82a of the lower second restraining member 82.

Since the cell assembly 1 for structural observation of the present disclosure has the aforementioned configuration, the restraining force from the first main restraining member 7 and second main restraining member 8, which are the pair of main restraining members 4, to the cell 3 serving as the observation target extends as follows. The tension acting on both bolts 9, 10 by fastening the bolt 9 and bolt 10 generates force on the opposing first main restraining member 7 and second main restraining member 8 in a direction narrowing the gap of both.

As a result thereof, the pressure towards one surface of the cell 3 by the first main restraining member 7 transmits to the first auxiliary restraining member 5 and spacer 26 in this order, and pushes and restrains one side of the electrode opposing part 3b of the cell 3 in the normal vector direction thereof. Simultaneously, the force towards the other side of the cell 3 by the convex part 8a (convex part 81a of the upper second restraining member 81 and convex part 82a of the lower second restraining member 82) of the second main restraining member 8 transmits via the convex part 6a of the second auxiliary restraining member 6, and pushes and restrains the other side of the electrode opposing part 3b of the cell 3 in the normal vector direction thereof. The cell assembly 1 for structural observation of the present disclosure adopts an insulator as the first auxiliary restraining member 5 and second auxiliary restraining member 6 in this embodiment. The case of this embodiment can restrain the cell 3 which is the observation target in a state in which wasteful electrical continuity does not occur. However, it is also possible to assume an embodiment adopting a non-insulator as the first auxiliary restraining member 5 and second auxiliary restraining member 6.

The first main restraining member 7 is divided into the upper first restraining member 71 and lower first restraining member 72, and the second main restraining member 8 is divided into the upper second restraining member 81 and lower second restraining member 82. It is a configuration in which the upper first restraining member 71 and upper second restraining member 81 are respectively fastened by the bolt 9 at the upper end sides, and the lower first restraining member 72 and lower second restraining member 82 are respectively fastened by the bolt 10 at the lower end sides. For this reason, the restraining forces from the upper first restraining member 71 and upper second restraining member 81, as well as the lower first restraining member 72 and lower second restraining member 82 comes to act separately on upper and lower sides, respectively. Even if the restraining forces by the lower first restraining member 72 and lower second restraining member 82 act separately as mentioned above, it is necessary to cause sufficient restraining force only to restrain the expansion from both sides thereof to act on the electrode opposing part 3b of the cell 3.

Therefore, sufficient rigidity is required in the upper first restraining member 71 and lower first restraining member 72 of the first main restraining member 7, as well as the upper second restraining member 81 and lower second restraining member 82 of the second main restraining member 8.

For this reason, it is necessary for each to be members of the appropriate thickness dimension. When the thickness dimension of the first main restraining member 7 and second main restraining member 8, which are one pair of main restraining members 4, becomes larger, in the case of the cell assembly for structural observation of a type irradiating X-rays on the cell 3 serving as the observation target by penetrating the main restraining member, it disrupts clear structural observation due to absorption of X-rays by the main restraining member. In the case of the cell assembly 1 for structural observation of the present disclosure, since the gap g is provided along the irradiation direction of X-rays, the loss of X-rays functioning for structural observation is small, and clear structural observation is possible.

According to the cell assembly 1 for structural observation of the present disclosure, the following effects are exerted.

(1) The cell assembly 1 for structural observation includes the first main restraining member 7 and second main restraining member 8, which are one pair of main restraining members 4, and the first auxiliary restraining member 5 and second auxiliary restraining member 6. The first main restraining member 7 and second main restraining member 8 restrains the cell 3 serving as the observation target by sandwiching from both sides thereof. The first auxiliary restraining member 5 is inserted between the first main restraining member 7 and cell 3, and the second auxiliary restraining member 6 is inserted between the second main restraining member 8 and cell 3. The first main restraining member 7 includes the upper first restraining member 71 and lower first restraining member 72 which are partial restraining members, and the upper first restraining member 71 and lower first restraining member 72 are arranged with a predetermined parallel gap g1 between the two. The second main restraining member 8 includes the upper second restraining member 81 and lower second restraining member 82 which are partial restraining members, and the upper second restraining member 81 and lower second restraining member 82 are arranged with a parallel gap g2 between the two. The X-rays from the X-ray source of X-ray CT pass through the gaps g1, g2 and penetrate the electrode opposing part 3b of the cell 3 defined as the observation target. In the case of rotating the rotation support member 2 and relatively rotating the cell 3 around the pivot axis perpendicular to the optical axis of X-rays, even if the angle of incidence of X-rays approaches 90 degrees, the incidence of X-rays to the cell 3 is thereby not inhibited. On the other hand, since the first main restraining member 7 is partitioned into the upper first restraining member 71 and lower first restraining member 72 which are partial restraining members, and the second main restraining member 8 is partitioned into the upper second restraining member 81 and lower second restraining member 82 which are partial restraining members, and is a structure fixing each partial restraining member at one end, the necessity arises to increase the plate thickness of each partial restraining member in order to curb expansion of the cell 3. In contrast, by configuring so as to perform irradiation of X-rays on the electrode opposing part 3b of the cell 3 defined as the observation target through the gaps g1, g2, it is configured so that observation of the structure of the electrode opposing part 3b is not inhibited. Since there is no absorption of X-rays by the gaps g1, g2, it is possible to clearly observe the structure of the electrode opposing part 3b compared to a case of restraining the cell 3 by a main restraining member without the gap.

(2) The cell assembly 1 for structural observation includes the rotation support member 2 which supports the main restraining member 4 so as to rotate around an axis orthogonal to the plane defined by the irradiation direction of X-rays by X-ray CT and the longitudinal direction of the gap g. For this reason, it is possible to perform irradiation of X-rays to the electrode opposing part 3b of the cell 3 defined as the observation target over the entire circumference around the above-mentioned axis, and thus it is possible to obtain abundant information on the structure of the electrode opposing part 3b.

(3) In the cell assembly 1 for structural observation, the first auxiliary restraining member 5 and second auxiliary restraining member 6, which are the auxiliary restraining members, are insulators. It is thereby possible to restrain the cell 3 which is the observation target in a state in which useless electrical continuity does not occur.

(4) In the cell assembly 1 for structural observation, a fastening member (set of the bolt 9 and upper female thread hole 83, set of the bolt 10 and lower female thread hole 84) are separated from the electrode opposing part 3b which is the observation target site of the cell 3, and does not affect observation by X-ray CT.

(5) In the cell assembly for structural observation, since the positive electrode terminal 20 and negative electrode terminal 21 are separated from the electrode opposing part 3b which is the observation target site of the cell 3, operations on the positive electrode terminal 20 and negative electrode terminal 21 will not affect observation by X-ray CT.

(6) With the cell assembly for structural observation, since the positive electrode busbar housing 24 and negative electrode busbar housing 25 are separated from the electrode opposing part 3b which is the observation target site of the cell 2, operations on the positive electrode busbar 22 and negative electrode busbar 23 will not affect observation by X-ray CT.

### EXPLANATION OF REFERENCE NUMERALS

AS assembly

g, g1, g2 gap

1 cell assembly for structural observation

2 rotation support member

3 cell

3a cell body

3b electrode opposing part

4 main restraining member

5 first auxiliary restraining member

5d negative electrode busbar housing half

5u positive electrode busbar housing half

6 second auxiliary restraining member

6a convex part

6d negative electrode busbar housing half

6u positive electrode busbar housing half

7 first main restraining member

8 second main restraining member

9, 10 bolt

11, 12 bolt through hole

13, 14 recess

15 mounting member

16, 17 assembly mounting bolt

20 positive electrode terminal

21 negative electrode terminal

22 positive electrode busbar

23 negative electrode busbar

24 positive electrode busbar housing

24a window

25 negative electrode busbar housing

25a window

26 spacer

71 upper first restraining member

72 lower first restraining member

73 upper bolt insertion hole

74 lower bolt insertion hole

81 upper second restraining member

81a convex part

82 lower second restraining member

82a convex part

83 upper female thread hole

84 lower female thread hole

85 projecting member

86, 87 assembly mounting female thread hole

What is claimed is:

1. A cell assembly for structural observation for observing an internal structure of a cell by X-ray CT, the cell assembly comprising:
a pair of main restraining members which restrain the cell serving as an observation target by sandwiching from both sides thereof; and
an auxiliary restraining member which is relatively thinner than the main restraining member, and is interposed between each of the pair of the main restraining members and the cell,
wherein each of the pair of the main restraining members is configured by a plurality of partial restraining members disposed with a predetermined gap, and
wherein the auxiliary restraining member is disposed to overlap the gap of the main restraining members when viewed in a restraining direction of the cell.

2. The cell assembly structural for observation according to claim 1, further comprising a rotation support member which supports the main restraining member so as to rotate around an axis orthogonal to a plane defined by an irradiation direction of X-ray from the X-ray CT and a longitudinal direction of the gap.

3. The structural observation cell assembly according to claim 1, wherein the auxiliary restraining member is an insulator.

4. The cell assembly for structural observation according to claim 2, wherein two fastening members for fastening between a pair of the main restraining members are provided, the two of the fastening members being disposed to sandwich an electrode opposing part, which is an observation target site of the cell, in a rotation axis direction of rotation of the cell assembly for structural observation by way of the rotation support member.

5. The cell assembly for structural observation according to claim 2, wherein a positive electrode terminal and a negative electrode terminal drawn out from the cell are disposed to sandwich an electrode opposing part which is an observation target site of the cell, in a rotation axis direction of rotation of the structural observation cell assembly by way of the rotation support member.

6. The cell assembly for structural observation according to claim 5, wherein a positive electrode busbar housing and a negative electrode busbar housing are respectively provided so as to house a positive electrode busbar connected to the positive electrode terminal and a negative electrode busbar connected to the negative electrode terminal, and the positive electrode busbar housing and the negative electrode busbar housing are disposed to sandwich the electrode opposing part which is an observation target site of the cell, in a rotation axis direction of rotation of the cell assembly for structural observation by way of the rotation support member.
